(19) United States
(12) Patent Application Publication
(10) Pub. No.: US 2010/0209757 A1
(43) Pub. Date: Aug. 19, 2010

(54) NONAQUEOUS ELECTROLYTE SECONDARY BATTERY

(75) Inventors: Tomoyo Ooyama, Fukushima (JP); Atsushi Kajita, Fukushima (JP); Atsushi Nishimoto, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/703,505

(22) Filed: Feb. 10, 2010

(30) Foreign Application Priority Data
Feb. 17, 2009 (JP) P2009-033959

(51) Int. Cl. H01M 2/16; H01M 6/18

(52) U.S. Cl. 429/144; 429/316; 429/317

(57) ABSTRACT

A nonaqueous electrolyte secondary battery includes a positive electrode, a negative electrode, a nonaqueous electrolyte, and a separator. The positive electrode includes a lithium composite oxide having an average composition represented by the following formula (1)

LiₓCo_{y}Ni_{z}M_{1-y-z}O_{b-a}Xₐ (1)

The separator includes a base layer and a polymer resin layer provided on at least one primary surface of the base layer, and the polymer resin layer includes at least one of poly(vinylidene fluoride), poly(vinyl formal), poly(acrylic ester), and poly(methyl methacrylate).

In the above formula (1), M indicates at least one element selected of boron, magnesium, aluminum, silicon, phosphorous, sulfur, titanium, chromium, manganese, iron, copper, zinc, gallium, germanium, yttrium, zirconium, molybdenum, silver, strontium, cesium, barium, tungsten, indium, tin, lead, and antimony. X represents a halogen element. X, y, z, a, and b respectively satisfy 0.8<x≦1.2, 0≦y≦1.0, 0.5≦z≦1.0, 0≦a≦1.0, and 1.8≦b≦2.2. Also, y<z is satisfied.

### CROSS REFERENCES TO RELATED APPLICATIONS

The present application claims priority to Japanese Priority Patent Application JP 2009-033959 filed in the Japan Patent Office on Feb. 17, 2009, the entire content of which is hereby incorporated by reference.

### BACKGROUND

The present disclosure relates to a nonaqueous electrolyte secondary battery. In particular, the present disclosure relates to a nonaqueous electrolyte secondary battery using a lithium composite oxide which contains a large amount of a nickel component.

In recent years, concomitant with the spread of portable apparatuses, such as a video camera and a notebook personal computer, compact and high-capacity secondary batteries have been increasingly in demand. Although most secondary batteries which have been used are nickel-cadmium batteries each using an alkaline electrolytic solution, the battery voltage is low, such as approximately 1.2 V, and hence the energy density is difficult to be improved. Accordingly, a lithium secondary battery using a lithium metal has been studied since lithium has a specific gravity of 0.534 which is lightest among simple solid substances, a significantly base potential, and the highest current capacity per unit weight among metal negative electrode materials.

However, in a secondary battery using a lithium metal as a negative electrode, dendritically-shaped lithium (dendrite) is deposited on the surface of the negative electrode during charge and is grown by charge-discharge cycles. The growth of this dendrite not only degrades cycle characteristics of the secondary battery but also, in the worst case, breaks through a separator disposed to prevent the contact between the negative electrode and the positive electrode, and since the negative electrode is electrically short-circuited with the positive electrode, ignition occurs, so that the battery is destroyed thereby. Accordingly, for example, as disclosed in Japanese Unexamined Patent Application Publication No. 62-90863, a secondary battery has been proposed in which a carbonaceous material, such as coke, is used for a negative electrode, and charge and discharge are repeatedly performed by doping and dedoping of alkali metal ions. By this technique, it was found that a degradation problem of the negative electrode caused by repeated charge-discharge operations can be avoided.

In addition, through research and development of an active material exhibiting a high potential used as a positive electrode active material, materials exhibiting a battery voltage of approximately 4 V were discovered, and attention has been paid thereto. As the active materials mentioned above, inorganic compounds, such as a transition metal oxide containing an alkali metal and a transition metal chalcogen, have been disclosed. Among those mentioned above, LiₓCoO₂ (0<x≦1.0), LiₓNiO₂ (0<x≦1.0), and the like are most promising materials in terms of a high potential, stability, and long life. Among the above materials, a positive electrode material represented by LiNiO₂ (hereinafter referred to as “high-nickel positive electrode material) in which the amount of a nickel component is larger than that of a cobalt component has a high discharge capacity as compared to that of LiₓCoO₂ and is an attractive positive electrode material.

However, on the surface of LiₓNiO₂, besides LiOH and the like present as impurities which are residues of a positive electrode raw material, a large amount of Li₂CO₃ generated when LiOH absorbs a carbon dioxide gas in the air is present as compared to that in the case of LiₓCoO₂. Among the impurities, LiOH functioning as an alkaline component facilitates decomposition of an electrolytic solution, so that CO₂ and CO₃ gases are generated. Although hardly dissolved in a solvent and an electrolytic solution, Li₂CO₃ is decomposed by charge-discharge operations, and as a result, CO₂ and CO₃ gases are also generated. These gas components increase the pressure inside the battery, thereby causing swelling of the battery and/or degradation in cycle life thereof. When an exterior package of the battery has a high strength by a stainless steel can or an aluminum can, because of an increase in inside pressure caused by the gas generation, explosion may occur in some cases. In addition, when the exterior package is formed of a laminate film, the battery easily swells, and the distance between the electrodes is increased, so that a problem in that charge-discharge operations are not conducted may arise.

That is, since an active material containing a large amount of a nickel component used as a positive electrode material seriously degrades battery characteristics due to the gas generation, there has been a problem in that the cycle life determined by charge and discharge is considerably inferior to that of LiₓCoO₂. Furthermore, since the distance between the electrodes is increased by the gas generation, charge and discharge may not be conducted, and since the electrode positions are easily displaced, short circuit occurs, so that the safety of the battery is also disadvantageously degraded.

Hence, in a nonaqueous electrolyte secondary battery using a lithium composite oxide which contains a large amount of a nickel component, it is desirable to provide a nonaqueous electrolyte secondary battery which improves the cycle characteristics and which can suppress the degradation in safety of the battery.

### SUMMARY

According to an embodiment, there is provided a nonaqueous electrolyte secondary battery which includes a positive electrode; a negative electrode; a nonaqueous electrolyte; and a separator, and in this nonaqueous electrolyte secondary battery, the positive electrode includes a lithium composite oxide having an average composition represented by the following formula (1), the separator includes a base layer and a polymer resin layer provided on at least one primary surface of the base layer, and the polymer resin layer includes at least one of poly(vinylidene fluoride), poly(vinyl formal), poly(acrylic ester), and poly(methyl methacrylate).

LiₓCo_{y}Ni_{z}M_{1-y-z}O_{b-a}Xₐ (1)

In the above formula, M indicates at least one element selected from the group consisting of boron (B), magnesium (Mg), aluminum (Al), silicon (Si), phosphorous (P), sulfur (S), titanium (Ti), chromium (Cr), manganese (Mn), iron (Fe), copper (Cu), zinc (Zn), gallium (Ga), germanium (Ge), yttrium (Y), zirconium (Zr), molybdenum (Mo), silver (Ag), strontium (Sr), cesium (Cs), barium (Ba), tungsten (W), indium (In), tin (Sn), lead (Pb), and antimony (Sb); X represents a halogen element; x, y, z, a, and b respectively satisfy 0.8<x≦1.2, 0≦y≦1.0, 0.5≦z≦1.0, 0≦a≦1.0, and 1.8≦b≦2.2; and y<z is satisfied.

According to an embodiment, there is provided a nonaqueous electrolyte secondary battery which includes a positive electrode; a negative electrode; a nonaqueous electrolyte; and a separator, and in the above nonaqueous electrolyte secondary battery, the positive electrode includes a lithium composite oxide having an average composition represented by the following formula (1), the nonaqueous electrolyte includes a swollen polymer impregnated with an electrolytic solution, and the polymer includes at least one of poly(vinylidene fluoride), poly(vinyl formal), poly(acrylic ester), and poly(methyl methacrylate).

LiₓCo_{y}Ni_{z}M_{1-y-z}O_{b-a}Xₐ (1)

In the above formula, M indicates at least one element selected from the group consisting of boron (B), magnesium (Mg), aluminum (Al), silicon (Si), phosphorous (P), sulfur (S), titanium (Ti), chromium (Cr), manganese (Mn), iron (Fe), copper (Cu), zinc (Zn), gallium (Ga), germanium (Ge), yttrium (Y), zirconium (Zr), molybdenum (Mo), silver (Ag), strontium (Sr), cesium (Cs), barium (Ba), tungsten (W), indium (In), tin (Sn), lead (Pb), and antimony (Sb); X represents a halogen element; x, y, z, a, and b respectively satisfy 0.8<x≦1.2, 0≦y≦1.0, 0.5≦z≦1.0, 0≦a≦1.0, and 1.8≦b≦2.2; and y<z is satisfied.

According to an embodiment, in the case of a high-nickel positive electrode material represented by LiNiO₂ which contains a nickel component in an amount larger than that of a cobalt component, a separator including a polymer resin layer or an electrolyte in which a polymer is swollen with an electrolytic solution is used. This polymer resin layer or the electrolyte polymer includes at least one of poly(vinylidene fluoride), poly(vinyl formal), poly(acrylic ester), and poly(methyl methacrylate). Accordingly, the adhesive force between the electrode and the separator is increased, so that the generation of short circuit can be suppressed. In addition, by the improvement in adhesive force, swelling caused by an increase in distance between the electrodes can be suppressed, and as a result, leakage of an electrolytic solution can be prevented.

As described above, according to an embodiment, in a nonaqueous electrolyte secondary battery using a lithium composite oxide which contains a large amount of a nickel component, the cycle characteristics are improved, and the degradation in safety of the battery can also be suppressed.

Additional features and advantages are described herein, and will be apparent from the following Detailed Description and the figures.

### BRIEF DESCRIPTION OF THE FIGURES

FIG. 1 is a cross-sectional view showing one structural example of a nonaqueous electrolyte secondary battery according to one embodiment;

FIG. 2 is a partially enlarged cross-sectional view of a wound electrode body shown in FIG. 1;

FIG. 3 is a perspective view showing one structural example of a nonaqueous electrolyte secondary battery according to a third embodiment; and

FIG. 4 is a cross-sectional view showing a cross-sectional structure of the wound electrode body taken along the line IV-IV shown in FIG. 3.

### DETAILED DESCRIPTION

Embodiments will be described in the following order with reference to the drawings.

(1) First embodiment (example of a cylindrical type battery)

(2) Second embodiment (first example of a flat type battery)

(3) Third embodiment (second example of the flat type battery)

### 1. First Embodiment

### Structure of a Battery

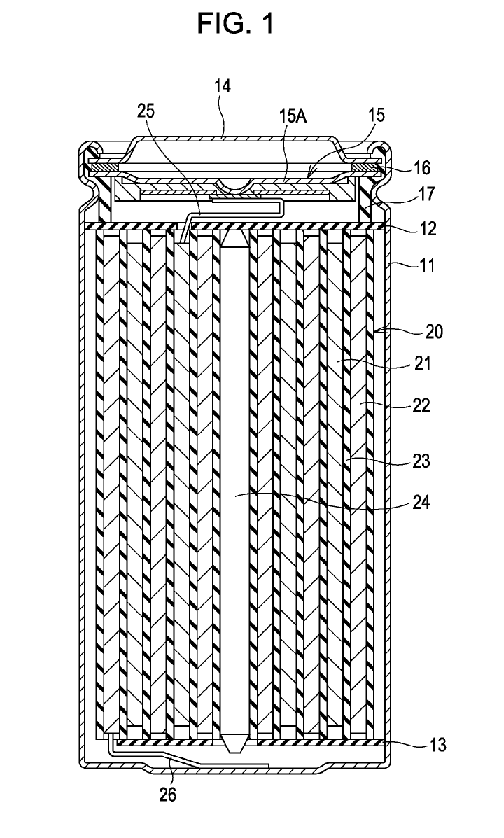

FIG. 1 is a cross-sectional view showing a cross-sectional structure of a nonaqueous electrolyte secondary battery according to one embodiment. This nonaqueous electrolyte secondary battery is a so-called lithium-ion secondary battery in which the capacity of a negative electrode is represented by a capacity component determined by occlusion and release of lithium (Li) which is an electrode reaction material. This nonaqueous electrolyte secondary battery is a so-called cylindrical type, and in a battery can 11 having an approximately hollow cylindrical shape, there is provided a wound electrode body 20 formed of a pair of a belt-shaped positive electrode 21 and a belt shaped negative electrode 22 which are laminated and wound with a separator 23 interposed therebetween. The battery can 11 is formed of iron (Fe) plated with nickel (Ni), one end portion of the can is closed, and the other end portion is open. An electrolytic solution is charged in the battery can 11 so that the separator 23 is impregnated with the electrolytic solution. In addition, a pair of the insulating plates 12 and 13 is disposed perpendicular to a wound circumferential surface so as to sandwich the wound electrode body 20.

A battery lid 14, a safety valve mechanism 15, and a thermal sensitive resistor 16 having a positive temperature coefficient (PTC element) are caulked to an open end portion of the battery can 11 with a sealing gasket 17 interposed therebetween, the safety valve mechanism 15 and the thermal sensitive resistor 16 being provided inside the battery lid 14. Accordingly, the inside of the battery can 11 is tightly sealed. The battery lid 14 is formed, for example, of a material similar to that of the battery can 11. The safety valve mechanism 15 is electrically connected to the battery lid 14 and is configured to disconnect the electrical connection between the battery lid 14 and the wound electrode body 20 by the inversion of a disc plate 15A which occurs when internal short circuit occurs or an inside pressure of the battery reaches a predetermined value or more by heating or the like. The gasket 17 is formed, for example, of an insulating material, and asphalt is applied to the surface thereof.

In the center of the wound electrode body 20, for example, a center pin 24 is inserted. A positive electrode lead 25 made of aluminum (Al) or the like is connected to the positive electrode 21 of the wound electrode body 20, and a negative electrode lead 26 made of nickel or the like is connected to the negative electrode 22.

The positive electrode lead 25 is electrically connected to the battery lid 14 since being welded to the safety valve mechanism 15, and the negative electrode lead 26 is welded to the battery can 11 and is electrically connected thereto.

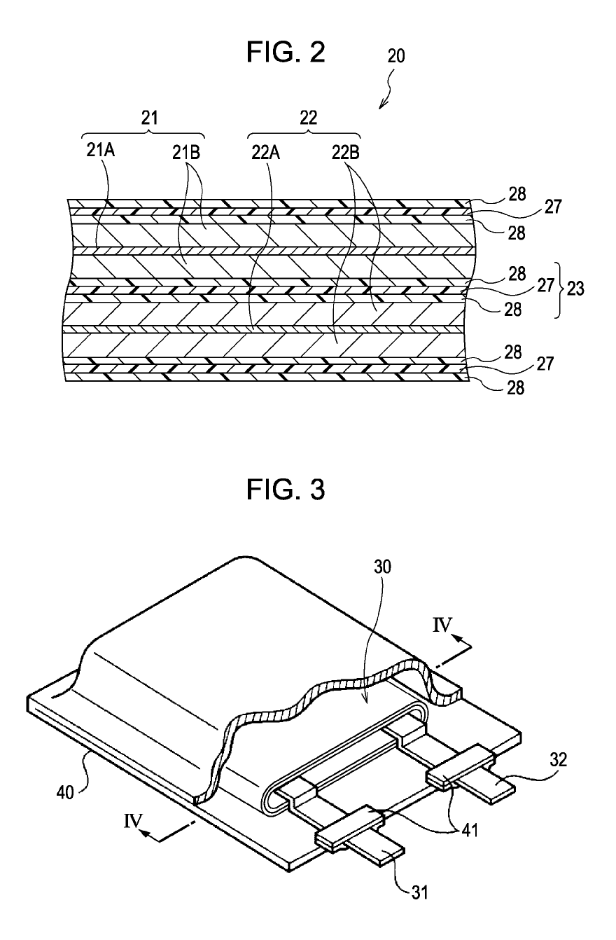

FIG. 2 is a partially enlarged cross-sectional view of the wound electrode body 20 shown in FIG. 1. Hereinafter, with reference to FIG. 2, the positive electrode 21, the negative electrode 22, the separator 23, and the electrolytic solution, which form the secondary battery, will be sequentially described.

(Positive Electrode)

The positive electrode 21 has, for example, the structure in which positive electrode active material layers 21B are provided on two surfaces of a positive electrode collector 21A having a pair of surfaces. The positive electrode collector 21A is formed, for example, of a metal foil, such as an aluminum foil. The positive electrode active material layer 21B includes as a positive electrode active material, for example, at least one type of positive electrode material capable of occluding and releasing lithium and, whenever necessary, also includes a conductive agent, such as graphite, and a binding agent, such as poly(vinylidene fluoride).

As the positive electrode active material capable of occluding and releasing lithium, a lithium composite oxide containing a nickel component in an amount larger than that of a cobalt component is preferably used. As the lithium composite oxide, for example, a lithium composite oxide having an average composition represented by the following formula (1) can be used.

LiₓCo_{y}Ni_{z}M_{1-y-z}O_{b-a}Xₐ (1)

In the above formula, M indicates at least one element selected from the group consisting of boron (B), magnesium (Mg), aluminum (Al), silicon (Si), phosphorous (P), sulfur (S), titanium (Ti), chromium (Cr), manganese (Mn), iron (Fe), copper (Cu), zinc (Zn), gallium (Ga), germanium (Ge), yttrium (Y), zirconium (Zr), molybdenum (Mo), silver (Ag), strontium (Sr), cesium (Cs), barium (Ba), tungsten (W), indium (In), tin (Sn), lead (Pb), and antimony (Sb); X represents a halogen element; x, y, z, a, and b respectively satisfy 0.8<x≦1.2, 0≦y≦1.0, 0.5≦z≦1.0, 0≦a≦1.0, and 1.8≦b≦2.2; and y<z is satisfied.

When the positive electrode active material includes a carbonate and a bicarbonate as impurities besides the lithium composite oxide, the total concentration of the carbonate and bicarbonate is preferably 0.3% or less which is obtained by an analysis in accordance with a method shown by Japanese Industrial Standard JIS-R-9101. The reason for this is that when the total concentration of a carbonate and a bicarbonate is set to 0.3% or less, the gas generation can be suppressed. In this case, the total concentration of the lithium composite oxide, a carbonate, and a bicarbonate are set to 100%.

(Negative Electrode)

As in the case of the positive electrode 21, the negative electrode 22 has, for example, the structure in which negative electrode active material layers 22B are provided on two surfaces of a negative electrode collector 22A having a pair of surfaces. The negative electrode collector 22A is formed, for example, of a metal foil, such as a copper (Cu) foil. The negative electrode active material layer 22B includes as a negative electrode active material, for example, at least one type of negative electrode material capable of occluding and releasing lithium and, whenever necessary, may also include a conductive agent and a binding agent.

As the negative electrode active material capable of occluding and releasing lithium, for example, a carbon material, such as black lead (graphite), non-graphatizable carbon, or graphatizable carbon, may be mentioned. Any one of the above carbon materials may be used alone, at least two thereof may be used in combination, or at least two types having different average particle diameters may be used in combination.

In addition, as the negative electrode material capable of occluding and releasing lithium, there may be mentioned a material including a metal element or a half-metal element as a constituent element which is capable of forming an alloy with lithium. In particular, for example, there may be mentioned a simple metal element capable of forming a an alloy with lithium, an alloy of the above element, or a compound thereof; a simple half-metal element capable of forming a an alloy with lithium, an alloy of the above half-metal element, or a compound thereof; or a material containing at least one phase of those mentioned above as a part of the material.

As the metal element or the half-metal element described above, for example, there may be mentioned tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), or hafnium (Hf). Among those mentioned above, a metal element or a half-metal element of Group XIV in the long-period periodic table is preferable, and silicon (Si) or tin (Sn) is particularly preferable. The reasons for this are that silicon (Si) and tin (Sn) each have an excellent ability of occluding and releasing lithium and are each able to obtain a high energy density.

As the alloy of silicon (Si), for example, as a second constituent element other than silicon (Si), at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) may be mentioned. As the alloy of tin (Sn), for example, as a second constituent element other than tin (Sn), at least one selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) may be mentioned.

As the compound of silicon (Si) or the compound of tin (Sn), for example, a compound containing oxygen (O) or carbon (C) may be mentioned, and besides silicon (Si) or tin (Sn), the second constituent element mentioned above may also be contained.

(Separator)

While isolating between the positive electrode 21 and the negative electrode 22 to prevent short circuit of current by the contact therebetween, the separator 23 enables lithium ions to pass therethrough. The separator 23 has a film-shaped base layer 27 and at least one polymer resin layer 28 provided on at least one primary surface of the base layer 27. In FIG. 2, an example in which the polymer resin layers 28 are formed on the two primary surfaces of the base layer 27 is shown.

The base layer 27 is preferably a microporous film primarily composed of a polyolefinic resin. The reason for this is that a polyolefinic resin has a superior short-circuit preventing effect and is also able to improve battery safety by its shutdown effect. As the polyolefinic resin, polyethylene and polypropylene are preferably used alone or in combination.

The polymer resin layer 28 includes at least one of poly(vinylidene fluoride) represented by the following formula (2), poly(vinyl formal) represented by the following formula (3), poly(acrylic ester) represented by the following formula (4), and poly(methyl methacrylate) represented by the following formula (5). Since the polymer resin layer 28 includes at least one of these resins, the adhesive force between the positive electrode 21 and the separator 23 and/or the adhesive force between the negative electrode 22 and the separator 23 can be improved. That is, the generation of short circuit or the like can be suppressed.

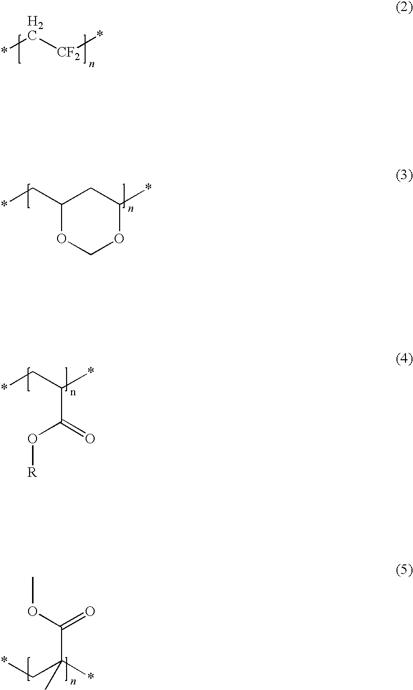

The polymer resin layer 28 includes, for example, a resin having the structure in which skeletons having a diameter of 1 μm or less are connected to each other to form a three-dimensional mesh shape. The structure in which skeletons having a diameter of 1 μm or less are connected to each other to form a three-dimensional mesh shape can be confirmed by observation using a scanning electron microscope (SEM). Since having the structure in which skeletons having a diameter of 1 μm or less are connected to each other to form a three-dimensional mesh shape, the polymer resin layer 28 is excellent in impregnation with an electrolytic solution, and since the structure described above has a high void rate, superior ion permeability can be obtained.

A surface open rate of the polymer resin layer 28 is preferably in the range of 30% to 80%. The reasons for this are that when the surface open rate is too small, the ionic conductivity is degraded, and that when it is too large, the function imparted by the resin is insufficient.

The surface open rate is observed by a SEM and is calculated, for example, in a manner as described below. In a SEM image observed by a SEM, an area from the surface to a depth of 1 μm which corresponds to the diameter of the skeleton is regarded as a skeleton's occupied area. A region R extracted by image processing is calculated as the skeleton's occupied area. The surface open rate is calculated by dividing a value obtained by subtracting the skeleton's occupied area from the entire area of the SEM image by the entire area of the SEM image. That is, the surface open rate can be obtained by “Surface open rate (%)”={(“entire area”−“skeleton's occupied area”)/“entire area”×100(%).

The polymer resin layer 28 preferably includes fine particles primarily composed of an inorganic material. The reasons for this are that when the fine particles as described above are included, oxidation resistance of the separator 23 is improved, and degradation of battery characteristics can be suppressed. As the inorganic material included in the fine particles, at least one of alumina (Al₂O₃), silica (SiO₂) and titania (TiO₂) is preferably used. The average particle diameter of the fine particles is preferably in the range of 1 nm to 3 μm. The reasons for this are that when the average particle diameter is less than 1 nm, since the crystallinity of ceramic is insufficient, the addition effect is not obtained, and that when the average particle diameter is more than 3 μm, the fine particles are not sufficiently dispersed.

(Electrolytic Solution)

The electrolytic solution functioning as an electrolyte includes a solvent and an electrolyte salt dissolved therein. As the solvent, a cyclic carbon ester, such as ethylene carbonate or propylene carbonate, may be used, and ethylene carbonate and propylene carbonate are preferably used alone or, in particular, preferably in combination. The reason for this is that the cycle characteristics can be improved.

In addition, as the solvent, a chain carbonate ester, such as diethyl carbonate, dimethyl carbonate, ethyl methyl carbonate, or methyl isopropyl carbonate, is preferably used in combination with at least one of those cyclic carbonate esters. The reason for this is that a high ionic conductivity can be obtained.

Furthermore, as the solvent, 2,4-difluoroanisol or vinylene carbonate is preferably included. The reasons for this are that 2,4-difluoroanisol can improve the discharge capacity, and that vinylene carbonate can improve the cycle characteristics. Hence, when those described above are used in combination, the discharge capacity and the cycle characteristics can be preferably improved.

As the solvent, besides those mentioned above, for example, there may also be mentioned butylene carbonate, γ-butyrolactone, γ-valerolactone, 1,2-dimethoxyethane, tetrahydrofuran, 2-methyltetrahydrofuran, 1,3-dioxolan, 4-methyl-1,3-dioxolan, methyl acetate, methyl propionate, acetonitrile, glurtaronitrile, adiponitrile, methoxyacetonitrile, 3-methoxypropionitrile, N,N-dimethylformamide, N-methylpyrrolidinone, N-methyloxazolidinone, N,N-dimethylimidazolidinone, nitromethane, nitroethane, sulfolane, dimethyl sulfoxide and trimethyl phosphate.

In addition, since the reversibility of the electrode reaction may be improved in some cases, a compound formed by replacing at least part of hydrogen of each of these nonaqueous solvents with fluorine may be preferably used depending on the type of electrode to be used in combination.

As the electrolyte salt, for example, lithium salts may be mentioned, and one type may be used alone, or at least two types may also be used in combination. As the lithium salt, for example, LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bisoxalatoborate or LiBr may be mentioned. Among these mentioned above, LiPF6 is preferable since a high ionic conductivity can be obtained and the cycle characteristic can also be improved.

[Manufacturing Method of the Battery]

The nonaqueous electrolyte secondary battery having the above structure can be manufactured, for example, in a manner as described below.

(Formation Step of the Positive Electrode)

First, for example, the positive electrode active material, the conductive agent, and the binding agent, which are described above, are mixed to prepare a positive electrode mixture, and this positive electrode mixture is dispersed in a solvent such as N-methyl-2-pyrrolidone to form a positive electrode mixture slurry in the form of a paste. Next, after this positive electrode mixture slurry is applied to the positive electrode collector 21A, the solvent is dried, and compression molding is performed using a roll press machine or the like to form the positive electrode active material layers 21B, so that the positive electrode 21 is formed.

(Formation Step of the Negative Electrode)

First, for example, the negative electrode active material, the conductive agent, and the binding agent are mixed to prepare a negative electrode mixture, and this negative electrode mixture is dispersed in a solvent such as N-methyl-2-pyrrolidone to form a negative electrode mixture slurry in the form of a paste. Next, after this negative electrode mixture slurry is applied to the negative electrode collector 22A, the solvent is dried, and compression molding is performed using a roll press machine or the like to form the negative electrode active material layers 22B, so that the negative electrode 22 is formed.

(Formation Step of the Separator)

First, a slurry including a matrix resin and a solvent is formed. In addition, whenever necessary, fine particles primarily composed of an inorganic material may also be added to the slurry. In this case, the matrix resin is at least one of poly(vinylidene fluoride), poly(vinyl formal), poly(acrylic ester), and poly(methyl methacrylate). Next, the slurry thus formed is applied on the base layer 27 and is allowed to pass through a bath containing a solvent which is a poor solvent to the matrix resin and a good solvent to the above solvent so as to cause phase separation, followed by drying. Accordingly, the separator 23 is obtained.

By the method described above, the polymer resin layer 28 is formed by a rapid poor solvent-induced phase separation phenomenon, and the polymer resin layer 28 has a fine three-dimensional mesh structure in which resin skeletons are connected to each other. That is, since the solution dissolving the resin is brought in contact with a solvent which is a poor solvent to the resin and a good solvent to the solvent dissolving the resin, the solvent exchange occurs. As a result, a rapid (high rate) phase separation is generated in association with the spinodal decomposition, so that the resin has a unique three-dimensional mesh structure.

In a wet method (phase separation method) generally used for forming a related separator, a resin and a solvent are mixed together, and a solution obtained therefrom by heating is formed into a sheet. Subsequently, by cooling, a temperature-induced phase separation phenomenon is generated in which the resin is precipitated in the form of a solid phase, so that origins (portions at which the solvent is present) of opening portions are formed. Next, after drawing is performed, the solvent is removed by extraction using another solvent to form a porous structure. On the other hand, instead of the temperature-induced phase separation phenomenon used in a wet method, the polymer resin layer 28 of the separator 23 used in one embodiment of the present invention uses a rapid poor solvent-induced phase separation phenomenon caused by a poor solvent which occurs in association with the spinodal decomposition, and hence a unique porous structure is formed. Furthermore, by the structure described above, excellent impregnation with the electrolyte and a superior ionic conductivity can be realized.

(Assembly Step)

Next, the positive electrode lead 25 is fitted to the positive electrode collector 21A by welding or the like, and the negative electrode lead 26 is fitted to the negative electrode collector 22A by welding or the like. Next, the positive electrode 21 and the negative electrode 22 are wound with the separator 23 interposed therebetween. Subsequently, a front end portion of the positive electrode lead 25 is welded to the safety valve mechanism 15, a front end portion of the negative electrode lead 26 is welded to the battery can 11, and the positive electrode 21 and the negative electrode 22 thus wound are sandwiched by the pair of insulating plates 12 and 13 and are received in the battery can 11. After the positive electrode 21 and the negative electrode 22 are received in the battery can 11, the electrolytic solution is supplied in the battery can 11 so that the separator 23 is impregnated with the electrolytic solution. Subsequently, the battery lid 14 and the safety valve mechanism 15 are fixed to the open end portion of the battery can 11 by caulking with the gasket 17 interposed therebetween. Accordingly, the nonaqueous electrolyte secondary battery shown in FIGS. 1 and 2 is formed.

In this nonaqueous electrolyte secondary battery, when the charge is performed, for example, lithium ions are released from the positive electrode active material 21B and are occluded in the negative electrode active material 22B through the electrolytic solution. In addition, when the discharge is performed, for example, lithium ions are released from the negative electrode active material 22B and are occluded in the positive electrode active material 21B through the electrolytic solution.

As described above, according to one embodiment, the polymer resin layer 28 including at least one of poly(vinylidene fluoride), poly(vinyl formal), poly(acrylic ester), and poly(methyl methacrylate) is formed on at least one primary surface of the base layer 27. Hence, the adhesive force between the positive electrode 21 and the separator 23 and/or the adhesive force between the negative electrode 22 and the separator 23 can be improved. Accordingly, the generation of short circuit or the like is suppressed, and the safety can be improved. In particular, when a positive electrode active material containing a large amount of a nickel component is used for the positive electrode 21, a significant effect of improving the safety can be obtained.

In addition, when fine particles primarily composed of an inorganic material is included in the polymer resin layer 28, the oxidation resistance of the separator 23 is improved, and the battery characteristics can be suppressed from being degraded.

### 2. Second Embodiment

### Structure of a Battery

FIG. 3 is a perspective view showing one structural example of a nonaqueous electrolyte secondary battery according to a second embodiment. This secondary battery is a so-called laminate film type in which a wound electrode body 30 provided with a positive electrode lead 31 and a negative electrode lead 32 is housed in a film-shaped exterior packaging member 40.

The positive electrode lead 31 and the negative electrode lead 32 extend outside from the inside of the exterior packaging member 40, for example, in the same direction. The positive electrode lead 31 and the negative electrode lead 32 are each formed, for example, of a metal material, such as aluminum, copper, nickel, or stainless steel, and each have a thin plate shape or a mesh shape.

The exterior packaging member 40 is formed of a rectangular aluminum laminate film including, for example, a nylon film, an aluminum foil, and a polyethylene film adhered to each other in this order. The exterior packaging member 40 is disposed so that a polyethylene film side faces the wound electrode body 30, and external peripheral portions of the exterior packaging member 40 are in close contact with each other by fusion or using an adhesive. Between the exterior packaging member 40 and the positive electrode lead 31/the negative electrode lead 32, close-contact films 41 are inserted to prevent the entry of outside air. The close-contact films 41 are each formed of a material, such as a polyolefinic resin including polyethylene, polypropylene, modified polyethylene, or modified polypropylene, which has close-contact properties to the positive electrode lead 31 and the negative electrode lead 32.

In addition, instead of the aluminum laminate film described above, the exterior packaging member 40 may be formed of a laminate film having a different structure, a polymer film of polypropylene or the like, or a metal film.

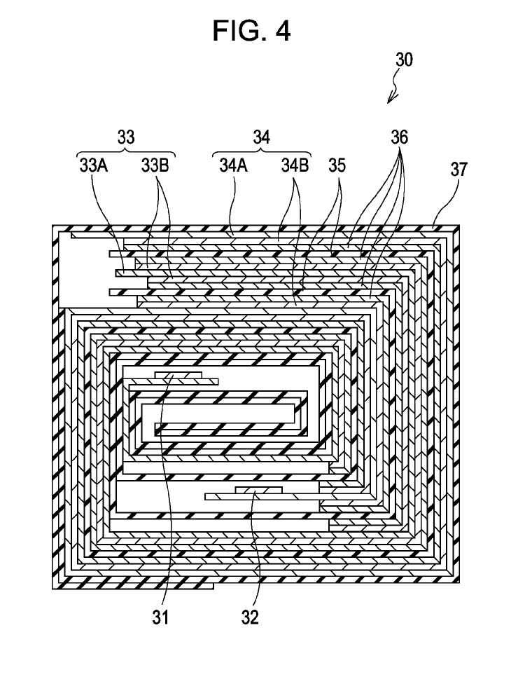

FIG. 4 is a cross-sectional view showing a cross-sectional structure of the wound electrode body 30 taken along the line IV-IV shown in FIG. 3. The wound electrode body 30 is formed by laminating and winding a positive electrode 33 and a negative electrode 34 with a separator 35 and electrolyte layers 36 interposed therebetween, and the outermost circumference portion is protected by a protective tape 37.

The positive electrode 33 has the structure in which at least one positive electrode active material layer 33B is provided on one or two surfaces of a positive electrode collector 33A. The negative electrode 34 has the structure in which at least one negative electrode active material layer 34B is provided on one or two surfaces of a negative electrode collector 34A. The negative electrode active material layer 34B and the positive electrode active material layer 33B are disposed to face each other. The structures of the positive electrode collector 33A, the positive electrode active material layer 33B, the negative electrode collector 34A, the negative electrode active material layer 34B, and the separator 35 are similar to those of the positive electrode collector 21A, the positive electrode active material layer 21B, the negative electrode collector 22A, the negative electrode active material layer 22B, and the separator 23, respectively.

The electrolyte layer 36 includes an electrolytic solution and a polymer resin which is swollen therewith and has a so-called gel form. A gel electrolyte is preferable since a high ionic conductivity is not only obtained but also leakage of battery liquid can be prevented. In addition, since a gel electrolyte holds an electrolytic solution, it has a superior contact ability with the active material and a superior ionic conductibility as compared to those of an entire solid electrolyte. As the polymer, at least one of poly(vinylidene fluoride), poly(vinyl formal), poly(acrylic ester), and poly(methyl methacrylate) is included. In addition, for example, an ether-based polymer compound, such as a cross-linked compound including polyethylene oxide or polypropylene oxide, may be further included in the electrolyte layer 36.

[Manufacturing Method of the Battery]

The nonaqueous electrolyte secondary battery having the above structure can be manufactured, for example, in a manner as described below.

First, a precursor solution containing an electrolytic solution, a polymer, and a solvent is applied to the positive electrode 33 and the negative electrode 34, and the solvent is then evaporated, so that the electrolyte layers 36 are formed. Subsequently, the positive electrode lead 31 is fitted to an end portion of the positive electrode collector 33A by welding or the like, and the negative electrode lead 32 is fitted to an end portion of the negative electrode collector 34A by welding or the like. Next, after the positive electrode 33 and the negative electrode 34, which are provided with the electrolyte layers 36, are laminated with the separator 35 interposed therebetween to form a laminate, this laminate is wound in a longitudinal direction, and the protective tape 37 is adhered to the outermost circumference portion, so that the wound electrode body 30 is formed. Finally, for example, the wound electrode body 30 is sandwiched by the exterior packaging member 40, and the external peripheral portions thereof are brought into close contact with each other by thermal fusion or the like for sealing. At this stage, the close-contact films 41 are inserted between the exterior packaging member 40 and the positive electrode lead 31/the negative electrode lead 32. Accordingly, the secondary battery shown in FIGS. 3 and 4 is completed.

In addition, this secondary battery may also be formed in a manner as described below. First, the positive electrode 33 and the negative electrode 34 are formed, and the positive electrode lead 31 and the negative electrode lead 32 are fitted to these positive electrode 33 and negative electrode 34, respectively. Next, the positive electrode 33 and the negative electrode 34 are laminated and wound with the separator 35 interposed therebetween, and the protective tape 37 is adhered to the outermost circumference portion of the laminate, so that a wound body which is a precursor of the wound electrode body 30 is formed. Subsequently, after this wound body is sandwiched by the exterior packaging member 40, the external peripheral portions of the exterior packaging member 40 except for one side thereof are thermally fused to each other to form a bag shape, and the wound body is received inside the exterior packaging member 40. Next, an electrolyte composition which includes an electrolytic solution, a monomer as a raw material for a polymer, a polymerization initiator, and other materials, whenever necessary, such as a polymerization inhibitor, is prepared and is then supplied in the exterior packaging member 40.

After the electrolyte composition is supplied, an opening portion of the exterior packaging member 40 is sealed by thermal fusion in a vacuum atmosphere. Next, the monomer is polymerized by heat application to form the polymer, and thereby the gel electrolyte layer 36 is formed, so that the secondary battery shown in FIGS. 3 and 4 is assembled.

The operation and the effect of the nonaqueous electrolyte secondary battery according to the second embodiment are similar to those described in the above first embodiment.

### 3. Third Embodiment

Next, a third embodiment of the present invention will be described. Hereinafter, constituent elements corresponding to those of the above second embodiment will be designated by the same reference numerals, and a description thereof will be omitted.

In the third embodiment, a polymer is applied to the separator 35, and after the battery is assembled, an electrolytic solution is supplied so that the polymer is swollen therewith. The points described above are different from those of the second embodiment.

A nonaqueous electrolyte secondary battery according to the third embodiment can be formed, for example, in a manner as described below. First, a slurry including a matrix resin and a solvent is formed. In this case, the matrix resin is at least one of poly(vinylidene fluoride) (PVdF), poly(vinyl formal), poly(acrylic ester), and poly(methyl methacrylate). Next, the slurry thus formed is applied on the base layer 27 which is a microporous film or the like and is then allowed to pass through a bath containing a solvent which is a poor solvent to the matrix resin and a good solvent to the above solvent so as to cause phase separation, followed by drying. Accordingly, at least one polymer resin layer is formed on the base layer, so that the separator 35 is obtained. Subsequently, after the positive electrode 33 and the negative electrode 34, which are provided with the electrolyte layers 36, are laminated to each other with the separator 35 interposed therebetween to form a laminate, this laminate is wound in a longitudinal direction, and the protective tape 37 is adhered to the outermost circumference portion, so that the wound electrode body 30 is formed. Next, for example, after the wound electrode body 30 is sandwiched by the exterior packaging member 40, the external peripheral portions except for on side thereof are thermally fused to form a bag shape, and the wound electrode body 30 is received in the exterior packaging member 40. Subsequently, from the side which is not thermally fused, a solvent is supplied in the exterior packaging member 40 so that the polymer of the polymer resin layer is swollen with the electrolytic solution, and the opening portion of the exterior packaging member 40 is then tightly sealed by thermal fusion. Accordingly, the nonaqueous electrolyte secondary battery can be obtained.

The operation and the effect of the nonaqueous electrolyte secondary battery according to the third embodiment are similar to those of the above first embodiment.

### EXAMPLES

Hereinafter, the present embodiments will be specifically described in detail with reference to examples; however, the present embodiments are not limited to these examples.

In the following examples and comparative examples, the average particle diameter of inorganic fine particles was measured using a dynamic scattering type particle size distribution measuring device (LB-550) manufactured by HORIBA, Ltd.

### Example 1

The positive electrode was formed as described below. First, composite oxide particles were prepared which had an average composition represented by Li_{0.98}Co_{0.15}Ni_{0.80}Al_{0.05}O_{2.1} and an average particle diameter of 14 μm measured by a laser scattering method. Next, 2 mass percent of poly(vinylidene fluoride) (PVdF) and 1 mass percent of graphite were added to this composite oxide particles and were sufficiently compounded with N-methyl-2-pyrrolidone for 1 hour, so that a positive electrode mixture slurry was formed. Subsequently, after this positive electrode mixture slurry was thinly applied to two surfaces of an Al foil and was then dried, cutting was performed to obtain a foil having a predetermined dimension, and vacuum drying was further performed at 100° C. or more, so that the positive electrode was obtained.

The negative electrode was formed as described below. First, 97 mass percent of graphite as a negative electrode active material and 3 mass percent of poly(vinylidene fluoride) (PVdF) as a binding agent were uniformly mixed with addition of N-methyl-2-pyrrolidone (NMP) to form a negative electrode mixture slurry. Subsequently, after this negative electrode mixture slurry was uniformly applied to two surfaces of a copper foil and was then dried, cutting was performed to obtain a foil having a predetermined dimension, and vacuum drying was further performed at 100° C. or more, so that the negative electrode was obtained.

The electrolytic solution was formed as described below. A solvent in an amount of 86 mass percent formed by mixing ethylene carbonate/ethyl methyl carbonate/4-fluoroethylene carbonate at a ratio of 39/60/1 (mass ratio) was mixed with 14 mass percent of lithium hexafluorophosphate to form the electrolytic solution.

The separator was formed as described below. First, poly(vinylidene fluoride) (average molecular weight: 150,000) was added with N-methyl-2-pyrrolidone at a mass ratio of 10:90 and was sufficiently dissolved therein. Accordingly, a slurry in which 10 mass percent of poly(vinylidene fluoride) was dissolved with respect to 90 mass percent of N-methyl-2-pyrrolidone was formed. Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film including PVdF microporous layers having a total thickness of 4 μm was obtained.

After the positive electrode and the negative electrode formed as described above were laminated to each other with the separator interposed therebetween and were wound, the laminate thus formed was received in a bag made of an aluminum laminate film. Subsequently, after 2 g of the electrolytic solution was charged in this bag, the bag was thermally fused, so that a laminate type battery was obtained. In this case, the rated capacity of this battery was set to 1,000 mAh.

### Example 2

A laminate type battery was obtained in a manner similar to that of Example 1 except that a positive electrode active material was used which was made of composite oxide particles having an average composition represented by Li_{0.98}Co_{0.15}Ni_{0.80}Mn_{0.05}O_{2.1} and an average particle diameter of 14 μm measured by a laser scattering method. In addition, the rated capacity of this battery was set to 970 mAh.

### Example 3

The separator was formed as described below. First, poly(vinyl formal) was added with N-methyl-2-pyrrolidone at a mass ratio of 10:90 and was sufficiently dissolved therein. Accordingly, a slurry in which 10 mass percent of poly(vinyl formal) was dissolved with respect to 90 mass percent of N-methyl-2-pyrrolidone was formed. Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film including poly(vinyl formal) microporous layers having a total thickness of 4 μm was obtained.

A laminate type battery was obtained in a manner similar to that of Example 1 except for those described above. In addition, the rated capacity of this battery was set to 1,000 mAh.

### Example 4

The separator was formed as described below. First, poly(acrylic ester) was added with N-methyl-2-pyrrolidone at a mass ratio of 10:90 and was sufficiently dissolved therein. Accordingly, a slurry in which 10 mass percent of poly(acrylic ester) was dissolved with respect to 90 mass percent of N-methyl-2-pyrrolidone was formed. Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film including poly(acrylic ester) microporous layers having a total thickness of 4 μm was obtained.

A laminate type battery was obtained in a manner similar to that of Example 1 except for those described above. In addition, the rated capacity of this battery was set to 1,000 mAh.

### Example 5

The separator was formed as described below. First, poly(methyl methacrylate) was added with N-methyl-2-pyrrolidone at a mass ratio of 10:90 and was sufficiently dissolved therein. Accordingly, a slurry in which 10 mass percent of poly(methyl methacrylate) was dissolved with respect to 90 mass percent of N-methyl-2-pyrrolidone was formed. Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film including poly(methyl methacrylate) microporous layers having a total thickness of 4 μm was obtained.

A laminate type battery was obtained in a manner similar to that of Example 1 except for those described above. In addition, the rated capacity of this battery was set to 1,000 mAh.

### Example 6

A separator including Al₂O₃ (alumina) in a polymer resin layer was formed as described below. First, poly(vinylidene fluoride) (average molecular weight: 150,000) was added with N-methyl-2-pyrrolidone at a mass ratio of 10:90 and was sufficiently dissolved therein. Accordingly, a slurry in which 10 mass percent of poly(vinylidene fluoride) was dissolved with respect to 90 mass percent of N-methyl-2-pyrrolidone was formed. Next, after fine Al₂O₃ (alumina) powder was added to the slurry thus formed so that the amount of Al₂O₃ was two times that of PVdF, this mixture was sufficiently stirred, so that a coating slurry was formed. As the Al₂O₃ (alumina) powder, a powder having an average particle diameter of 250 nm was used.

Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film was obtained which included PVdF microporous layers having a total thickness of 4 μm and including alumina.

A laminate type battery was obtained in a manner similar to that of Example 1 except for those described above.

### Example 7

A laminate type battery was obtained in a manner similar to that of Example 6 except that a positive electrode active material was used which was made of composite oxide particles having an average composition represented by Li_{0.98}Co_{0.15}Ni_{0.80}Mn_{0.05}O_{2.1} and an average particle diameter of 14 μm measured by a laser scattering method. In addition, the rated capacity of this battery was set to 970 mAh.

### Example 8

A separator including Al₂O₃ (alumina) in a polymer resin layer was formed as described below. First, poly(vinyl formal) was added with N-methyl-2-pyrrolidone at a mass ratio of 10:90 and was sufficiently dissolved therein. Accordingly, a slurry in which 10 mass percent of poly(vinyl formal) was dissolved with respect to 90 mass percent of N-methyl-2-pyrrolidone was formed. Next, after fine Al₂O₃ (alumina) powder was added to the slurry thus formed so that the amount of Al₂O₃ was two times that of poly(vinyl formal), this mixture was sufficiently stirred, so that a coating slurry was formed. As the Al₂O₃ (alumina) powder, a powder having an average particle diameter of 250 nm was used.

Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film was obtained which included poly(vinyl formal) microporous layers having a total thickness of 4 μm and including alumina.

A laminate type battery was obtained in a manner similar to that of Example 1 except for those described above.

### Example 9

A separator including Al₂O₃ (alumina) in a polymer resin layer was formed as described below. First, poly(acrylate ester) was added with N-methyl-2-pyrrolidone at a mass ratio of 10:90 and was sufficiently dissolved therein. Accordingly, a slurry in which 10 mass percent of poly(acrylate ester) was dissolved with respect to 90 mass percent of N-methyl-2-pyrrolidone was formed. Next, after fine Al₂O₃ (alumina) powder was added to the slurry thus formed so that the amount of Al₂O₃ was two times that of poly(acrylate ester), this mixture was sufficiently stirred, so that a coating slurry was formed. As the Al₂O₃ (alumina) powder, a powder having an average particle diameter of 250 nm was used.

Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film was obtained which included poly(acrylic ester) microporous layers having a total thickness of 4 μm and including alumina.

A laminate type battery was obtained in a manner similar to that of Example 1 except for those described above.

### Example 10

A separator including Al₂O₃ (alumina) in a polymer resin layer was formed as described below. First, poly(methyl methacrylate) was added with N-methyl-2-pyrrolidone at a mass ratio of 10:90 and was sufficiently dissolved therein. Accordingly, a slurry in which 10 mass percent of poly(methyl methacrylate) was dissolved with respect to 90 mass percent of N-methyl-2-pyrrolidone was formed. Next, after fine Al₂O₃ (alumina) powder was added to the slurry thus formed so that the amount of Al₂O₃ was two times that of poly(methyl methacrylate), this mixture was sufficiently stirred, so that a coating slurry was formed. As the Al₂O₃ (alumina) powder, a powder having an average particle diameter of 250 nm was used.

Next, the slurry thus formed was applied by a desktop coater to two surfaces of a microporous film of polyethylene (PE) having a thickness of 9 μm used as the base layer to have a thickness of 2 μm at each side. Subsequently, after the coated film was phase-separated in a water bath, drying was performed by hot wind, so that a microporous film was obtained which included poly(methyl methacrylate) microporous layers having a total thickness of 4 μm and including alumina.

A laminate type battery was obtained in a manner similar to that of Example 1 except for those described above.

### Example 11

A laminate type battery was obtained in a manner similar to that of Example 6 except that SiO₂ (silica) was used as inorganic fine particles.

### Example 12

A laminate type battery was obtained in a manner similar to that of Example 7 except that SiO₂ (silica) was used as inorganic fine particles.

### Example 13

A laminate type battery was obtained in a manner similar to that of Example 8 except that SiO₂ (silica) was used as inorganic fine particles.

### Example 14

A laminate type battery was obtained in a manner similar to that of Example 9 except that SiO₂ (silica) was used as inorganic fine particles.

### Example 15

A laminate type battery was obtained in a manner similar to that of Example 10 except that SiO₂ (silica) was used as inorganic fine particles.

### Example 16

A laminate type battery was obtained in a manner similar to that of Example 6 except that TiO₂ (titania) was used as inorganic fine particles.

### Example 17

A laminate type battery was obtained in a manner similar to that of Example 7 except that TiO₂ (titania) was used as inorganic fine particles.

### Example 18

A laminate type battery was obtained in a manner similar to that of Example 8 except that TiO₂ (titania) was used as inorganic fine particles.

### Example 19

A laminate type battery was obtained in a manner similar to that of Example 9 except that TiO₂ (titania) was used as inorganic fine particles.

### Example 20

A laminate type battery was obtained in a manner similar to that of Example 10 except that TiO₂ (titania) was used as inorganic fine particles.

### Example 21

A laminate type battery was obtained in a manner similar to that of Example 6 except that a slurry was applied to two surfaces of a polyethylene (PE) microporous film having a thickness of 9 μm used as the base layer to have a thickness of 10 μm at each side so as to form PVdF microporous layers having a total thickness of 4 μm and including alumina.

### Comparative Example 1

A laminate type battery was obtained in a manner similar to that of Example 1 except that a microporous single layer made of a polyethylene film having a thickness of 7 μm was used as the separator.

### Comparative Example 2

As the positive electrode active material, compound oxide particles having an average composition of Li_{1.02}Co_{0.15}Ni_{0.80}Mn_{0.05}O_{2.1} and an average particle diameter of 14 μm measured by a laser scattering method were used. In addition, as the separator, a microporous single layer made of a polyethylene film having a thickness of 9 μm was used. A laminate type battery was obtained in a manner similar to that of Example 1 except for those described above. In addition, the capacity of this battery was set to 1,000 mAh.

### Comparative Example 3

As the positive electrode active material, compound oxide particles having an average composition of Li_{1.02}Co_{0.98}Al_{0.01}Mg_{0.01}O_{2.1} and an average particle diameter of 12 μm measured by a laser scattering method were used. In addition, as the separator, a microporous single layer made of a polyethylene film having a thickness of 9 μm was used. A laminate type battery was obtained in a manner similar to that of Example 1 except for those described above. In addition, the capacity of this battery was set to 970 mAh.

### Comparative Example 4

A laminate type battery was obtained in a manner similar to that of Example 1 except that compound oxide particles having an average composition of Li_{1.02}Co_{0.98}Al_{0.01}Mg_{0.01}O_{2.1} and an average particle diameter of 12 μm measured by a laser scattering method were used. In addition, the capacity of this battery was set to 970 mAh.

### Comparative Example 5

A laminate type battery was obtained in a manner similar to that of Example 3 except that compound oxide particles having an average composition of Li_{1.02}Co_{0.98}Al_{0.01}Mg_{0.01}O_{2.1} and an average particle diameter of 12 μm measured by a laser scattering method were used. In addition, the capacity of this battery was set to 970 mAh.

### Comparative Example 6

A laminate type battery was obtained in a manner similar to that of Example 4 except that compound oxide particles having an average composition of Li_{1.02}Co_{0.98}Al_{0.01}Mg_{0.01}O_{2.1} and an average particle diameter of 12 μm measured by a laser scattering method were used. In addition, the capacity of this battery was set to 970 mAh.

### Comparative Example 7

A laminate type battery was obtained in a manner similar to that of Example 5 except that compound oxide particles having an average composition of Li_{1.02}Co_{0.98}Al_{0.01}Mg_{0.01}O_{2.1} and an average particle diameter of 12 μm measured by a laser scattering method were used. In addition, the capacity of this battery was set to 970 mAh.

### Comparative Example 8

A laminate type battery was obtained in a manner similar to that of Example 6 except that compound oxide particles having an average composition of Li_{1.02}Co_{0.98}Al_{0.01}Mg_{0.01}O_{2.1} and an average particle diameter of 12 μm measured by a laser scattering method were used. In addition, the capacity of this battery was set to 970 mAh.

### Comparative Example 9

A laminate type battery was obtained in a manner similar to that of Example 11 except that compound oxide particles having an average composition of Li_{1.02}Co_{0.98}Al_{0.01}Mg_{0.01}O_{2.1} and an average particle diameter of 12 μm measured by a laser scattering method were used. In addition, the capacity of this battery was set to 970 mAh.

### Comparative Example 10

A laminate type battery was obtained in a manner similar to that of Example 16 except that compound oxide particles having an average composition of Li_{1.02}Co_{0.98}Al_{0.01}Mg_{0.01}O_{2.1} and an average particle diameter of 12 μm measured by a laser scattering method were used. In addition, the capacity of this battery was set to 970 mAh.

For the laminate type batteries obtained as described above, the following evaluations were performed.

(Cycle Test)

After the battery was charged at 23° C. for 3 hours to an upper voltage limit of 4.2 V at 1C, discharge was repeatedly performed 500 times to 2.5 V at 1C. Next, by using a discharge capacity at the first cycle and that at the 500th cycle, the capacity retention rate after 500 cycles was obtained from the following equation. In this case, the “1C” indicates a current value at which the rated capacity of a battery is constant-current discharged for 1 hour.

Capacity retention rate (%)=(discharge capacity at 500th cycle/discharge capacity at first cycle)×100

(Storage Test)

After the battery was charged at 23° C. for 3 hours to an upper voltage limit of 4.2 V at 1C, the battery was stored for 12 hours at a temperature of 85° C. Next, the change in thickness of the battery before and after the storage performed in an atmosphere at 85° C. for 12 hours was obtained.

After the battery thus stored was held in an atmosphere at 23° C. for 12 hours, the battery was discharged at 23° C. to 2.5 V at 0.2C, and the remaining capacity was measured. Subsequently, charge to 4.2 V at a current of 1C and discharge to 2.5 V at a current of 0.2C were performed, so that the recovery capacity was measured.

(Floating Test)

The battery was charged so as to obtain an open circuit voltage of 4.2 V or more in a fully charged state at 23° C., and fluctuation in charge current value in a high-temperature overcharged state was examined. Hereinafter, the fluctuation in charge current value is called “floating characteristics”. The floating characteristics were measured in accordance with a constant current-constant voltage method performed for 500 hours in a high temperature bath in which the temperature was maintained at 60° C. In particular, after the constant current charge was started at 10 mA, when the voltage between terminals increased to a predetermined voltage, the charge was switched to a constant voltage charge. A time necessary for current rise after the constant voltage charge was measured and was regarded as a floating limit time.

The structures of the batteries of Examples 1 to 20 and Comparative Examples 1 to 11 and the evaluation results thereof are shown in Tables 1 and 2.

TABLE 1

| | POSITIVE ELECTRODE | SEPARATOR | |
|---|---|---|---|
| | ACTIVE MATERIAL | POLYMER RESIN LAYER | INORGANIC FINE PARTICLES |
| EXAMPLE 1 | Li_{0.98}Co_{0.15}Ni_{0.80}Al_{0.05}O_{2.1} | POLYMER RESIN LAYER | — |
| EXAMPLE 2 | Li_{0.98}Co_{0.15}Ni_{0.80}Mn_{0.05}O_{2.1} | POLY(VINYLIDENE FLUORIDE) | — |
| EXAMPLE 3 | Li_{0.98}Co_{0.15}Ni_{0.80}Al_{0.05}O_{2.1} | POLY(VINYL FORMAL) | — |
| EXAMPLE 4 | Li_{0.98}Co_{0.15}Ni_{0.80}Al_{0.05}O_{2.1} | POLY(ACRYLIC ESTER) | — |
| EXAMPLE 5 | Li_{0.98}Co_{0.15}Ni_{0.80}Al_{0.05}O_{2.1} | POLY(METHYL METHACRYLATE) | — |
| EXAMPLE 6 | Li_{0.98}Co_{0.15}Ni_{0.80}Al_{0.05}O_{2.1} | POLY(VINYLIDENE FLUORIDE) | Al₂O₃ |
| EXAMPLE 7 | Li_{0.98}Co_{0.15}Ni_{0.80}Mn_{0.05}O_{2.1} | POLY(VINYLIDENE FLUORIDE) | Al₂O₃ |
| EXAMPLE 8 | Li_{0.98}Co_{0.15}Ni_{0.80}Al_{0.05}O_{2.1} | POLY(VINYL FORMAL) | Al₂O₃ |
| EXAMPLE 9 | Li_{0.98}Co_{0.15}Ni_{0.80}Al_{0.05}O_{2.1} | POLY(ACRYLIC ESTER) | Al₂O₃ |
| EXAMPLE 10 | Li_{0.98}Co_{0.15}Ni_{0.80}Al_{0.05}O_{2.1} | POLY(METHYL METHACRYLATE) | Al₂O₃ |
| EXAMPLE 11 | Li_{0.98}Co_{0.15}Ni_{0.80}Al_{0.05}O_{2.1} | POLY(VINYLIDENE FLUORIDE) | SiO₂ |
| EXAMPLE 12 | Li_{0.98}Co_{0.15}Ni_{0.80}Mn_{0.05}O_{2.1} | POLY(VINYLIDENE FLUORIDE) | SiO₂ |
| EXAMPLE 13 | Li_{0.98}Co_{0.15}Ni_{0.80}Al_{0.05}O_{2.1} | POLY(VINYL FORMAL) | SiO₂ |
| EXAMPLE 14 | Li_{0.98}Co_{0.15}Ni_{0.80}Al_{0.05}O_{2.1} | POLY(ACRYLIC ESTER) | SiO₂ |
| EXAMPLE 15 | Li_{0.98}Co_{0.15}Ni_{0.80}Al_{0.05}O_{2.1} | POLY(METHYL METHACRYLATE) | SiO₂ |
| EXAMPLE 16 | Li_{0.98}Co_{0.15}Ni_{0.80}Al_{0.05}O_{2.1} | POLY(VINYLIDENE FLUORIDE) | TiO₂ |
| EXAMPLE 17 | Li_{0.98}Co_{0.15}Ni_{0.80}Mn_{0.05}O_{2.1} | POLY(VINYLIDENE FLUORIDE) | TiO₂ |
| EXAMPLE 18 | Li_{0.98}Co_{0.15}Ni_{0.80}Al_{0.05}O_{2.1} | POLY(VINYL FORMAL) | TiO₂ |
| EXAMPLE 19 | Li_{0.98}Co_{0.15}Ni_{0.80}Al_{0.05}O_{2.1} | POLY(ACRYLIC ESTER) | TiO₂ |
| EXAMPLE 20 | Li_{0.98}Co_{0.15}Ni_{0.80}Al_{0.05}O_{2.1} | POLY(METHYL METHACRYLATE) | TiO₂ |
| EXAMPLE 21 | Li_{0.98}Co_{0.15}Ni_{0.80}Al_{0.05}O_{2.1} | POLY(VINYLIDENE FLUORIDE) | Al₂O₃ |
| COMPARATIVE EXAMPLE 1 | Li_{0.98}Co_{0.15}Ni_{0.80}Al_{0.05}O_{2.1} | — | — |
| COMPARATIVE EXAMPLE 2 | Li_{1.02}Co_{0.15}Ni_{0.80}Mn_{0.05}O_{2.1} | — | — |
| COMPARATIVE EXAMPLE 3 | Li_{1.02}Co_{0.15}Al_{0.01}Mg_{0.01}O_{2.1} | — | — |
| COMPARATIVE EXAMPLE 4 | Li_{1.02}Co_{0.15}Al_{0.01}Mg_{0.01}O_{2.1} | POLY(VINYLIDENE FLUORIDE) | — |
| COMPARATIVE EXAMPLE 5 | Li_{1.02}Co_{0.15}Al_{0.01}Mg_{0.01}O_{2.1} | POLY(VINYL FORMAL) | — |
| COMPARATIVE EXAMPLE 6 | Li_{1.02}Co_{0.15}Al_{0.01}Mg_{0.01}O_{2.1} | POLY(ACRYLIC ESTER) | — |
| COMPARATIVE EXAMPLE 7 | Li_{1.02}Co_{0.15}Al_{0.01}Mg_{0.01}O_{2.1} | POLY(METHYL METHACRYLATE) | — |
| COMPARATIVE EXAMPLE 8 | Li_{1.02}Co_{0.15}Al_{0.01}Mg_{0.01}O_{2.1} | POLY(VINYLIDENE FLUORIDE) | Al₂O₃ |
| COMPARATIVE EXAMPLE 9 | Li_{1.02}Co_{0.15}Al_{0.01}Mg_{0.01}O_{2.1} | POLY(VINYLIDENE FLUORIDE) | SiO₂ |
| COMPARATIVE EXAMPLE 10 | Li_{1.02}Co_{0.15}Al_{0.01}Mg_{0.01}O_{2.1} | POLY(VINYLIDENE FLUORIDE) | TiO₂ |

TABLE 2

| | | | | | FLOATING TEST |
|---|---|---|---|---|---|
| | RETENTION RATE | 85° C. × 12 HOURS | | | 4.20 V, 60° C. |
| | AFTER 500 CYCLES | CHANGE IN BATTERY | REMAINING | RECOVERY | LIMIT TIME |
| | (%) | THICKNESS (mm) | CAPACITY (mAh) | CAPACITY (mAh) | (hr) |
| EXAMPLE 1 | 82 | 1.3 | 985 | 990 | 200 |
| EXAMPLE 2 | 80 | 1.0 | 945 | 960 | 220 |
| EXAMPLE 3 | 79 | 1.0 | 975 | 985 | 180 |
| EXAMPLE 4 | 80 | 1.0 | 982 | 990 | 180 |
| EXAMPLE 5 | 82 | 1.0 | 991 | 995 | 190 |
| EXAMPLE 6 | 83 | 0.9 | 990 | 995 | >300 |
| EXAMPLE 7 | 83 | 0.6 | 950 | 960 | >300 |
| EXAMPLE 8 | 80 | 0.7 | 985 | 990 | >300 |
| EXAMPLE 9 | 80 | 0.9 | 987 | 992 | >300 |
| EXAMPLE 10 | 81 | 0.7 | 988 | 993 | >300 |
| EXAMPLE 11 | 83 | 0.8 | 990 | 995 | >300 |
| EXAMPLE 12 | 83 | 0.5 | 950 | 960 | >300 |
| EXAMPLE 13 | 80 | 0.6 | 980 | 985 | >300 |
| EXAMPLE 14 | 80 | 0.9 | 987 | 992 | >300 |
| EXAMPLE 15 | 81 | 0.7 | 988 | 992 | >300 |
| EXAMPLE 16 | 81 | 0.9 | 984 | 992 | >300 |
| EXAMPLE 17 | 80 | 0.7 | 940 | 960 | >300 |
| EXAMPLE 18 | 80 | 0.7 | 980 | 985 | >300 |
| EXAMPLE 19 | 80 | 1.0 | 983 | 990 | >300 |
| EXAMPLE 20 | 81 | 0.7 | 980 | 990 | >300 |
| EXAMPLE 21 | 70 | 0.9 | 940 | 970 | 270 |
| COMPARATIVE EXAMPLE 1 | 70(300 CYCLES) | >5.0 | 0 | 0 | 50 |
| COMPARATIVE EXAMPLE 2 | 66(300 CYCLES) | >5.0 | 0 | 0 | 70 |
| COMPARATIVE EXAMPLE 3 | 80 | 1.0 | 945 | 955 | 150 |
| COMPARATIVE EXAMPLE 4 | 82 | 2.0 | 955 | 960 | 200 |
| COMPARATIVE EXAMPLE 5 | 79 | 2.4 | 930 | 950 | 170 |
| COMPARATIVE EXAMPLE 6 | 79 | 2.6 | 950 | 960 | 10 |
| COMPARATIVE EXAMPLE 7 | 80 | 2.4 | 940 | 950 | 185 |
| COMPARATIVE EXAMPLE 8 | 80 | 0.5 | 900 | 920 | >300 |
| COMPARATIVE EXAMPLE 9 | 80 | 0.6 | 890 | 917 | >300 |
| COMPARATIVE EXAMPLE 10 | 74 | 0.9 | 810 | 840 | >300 |

From Tables 1 and 2, the following are found.

### Examples 1 to 5 vs. Comparative Examples 1 and 2

Since the Polymer resin layer including poly(vinylidene fluoride), poly(vinyl formal), poly(acrylic ester), or poly(methyl methacrylate) is formed on the base layer, the change in battery thickness can be suppressed. Hence, the increase in distance between the electrodes is suppressed, and hence the degradation in safety of the battery can be suppressed.

### Examples 1 to 5 vs. Comparative Examples 1 and 2

Since the Polymer resin layer including poly(vinylidene fluoride), poly(vinyl formal), poly(acrylic ester), or poly(methyl methacrylate) is formed on the base layer, the capacity retention rate can be improved.

### Examples 6 to 20

Since alumina, silica, or titania is included in the polymer resin layer, the floating characteristics can be significantly improved.

### Examples 1 to 5 vs. Comparative Examples 4 to 7

When a Positive electrode active material containing a nickel component in an amount larger than that of a cobalt component is used, compared to the case in which a cobalt-based positive electrode active material is used, the effect of suppressing the change in battery thickness becomes significant.

### Examples 1 to 5 vs. Comparative Examples 4 to 7

When a Positive electrode active material containing a nickel component in an amount larger than that of a cobalt component is used, a capacity retention rate similar to that of a cobalt-based positive electrode active material can be obtained.

The structures, shapes, and values shown in the above embodiments are described by way of example, and whenever necessary, structures, shapes, and values different from those described above may also be used.

In addition, in the above embodiments, although the example in which the present embodiment is applied to batteries using an electrolytic solution and a gel electrolyte is described, the present invention may also be applied to an entire solid polymer electrolyte in which an electrolyte salt is dissolved in a polymer compound.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte secondary battery comprising:
a positive electrode;
a negative electrode;
a nonaqueous electrolyte; and
a separator,
wherein the positive electrode includes a lithium composite oxide having an average composition represented by the following formula (1),
LiₓCo_{y}Ni_{z}M_{1-y-z}O_{b-a}Xₐ (1)
the separator includes a base layer and a polymer resin layer provided on at least one primary surface of the base layer, and
the polymer resin layer includes at least one of poly(vinylidene fluoride), poly(vinyl formal), poly(acrylic ester), and poly(methyl methacrylate),
where, in the formula (1), M indicates at least one element selected from the group consisting of boron, magnesium, aluminum, silicon, phosphorous, sulfur, titanium, chromium, manganese, iron, copper, zinc, gallium, germanium, yttrium, zirconium, molybdenum, silver, strontium, cesium, barium, tungsten, indium, tin, lead, and antimony; X represents a halogen element; x, y, z, a, and b respectively satisfy 0.8<x≦1.2, 0≦y≦1.0, 0.5≦z≦1.0, 0≦a≦1.0, and 1.8≦b≦2.2; and y<z is satisfied.

2. The nonaqueous electrolyte secondary battery according to claim 1,
wherein the polymer resin layer includes fine particles primarily composed of an inorganic material.

3. The nonaqueous electrolyte secondary battery according to claim 2,
wherein the inorganic material comprises at least one of alumina, silica, and titania.

4. The nonaqueous electrolyte secondary battery according to claim 1,
wherein the fine particles have an average particle diameter in the range of 1 nm to 3 μm.

5. The nonaqueous electrolyte secondary battery according to claim 1,
wherein the positive electrode includes a carbonate and a bicarbonate, and
a total concentration of the carbonate and the bicarbonate is 0.3% or less.

6. The nonaqueous electrolyte secondary battery according to claim 1,
further comprising an exterior packaging member which houses the positive electrode, the negative electrode, the nonaqueous electrolyte, and the separator therein,
wherein the exterior packaging member is a container including a laminate film.

7. A nonaqueous electrolyte secondary battery comprising:
a positive electrode;
a negative electrode;
a nonaqueous electrolyte; and
a separator,
wherein the positive electrode includes a lithium composite oxide having an average composition represented by the following formula (1),
LiₓCo_{y}Ni_{z}M_{1-y-z}O_{b-a}Xₐ (1)
the nonaqueous electrolyte includes an electrolytic solution and a swollen polymer impregnated therewith, and
the polymer includes at least one of poly(vinylidene fluoride), poly(vinyl formal), poly(acrylic ester), and poly(methyl methacrylate),
where, in the formula (1), M indicates at least one element selected from the group consisting of boron, magnesium, aluminum, silicon, phosphorous, sulfur, titanium, chromium, manganese, iron, copper, zinc, gallium, germanium, yttrium, zirconium, molybdenum, silver, strontium, cesium, barium, tungsten, indium, tin, lead, and antimony; X represents a halogen element; x, y, z, a, and b respectively satisfy 0.8<x≦1.2, 0≦y≦1.0, 0.5≦z≦1.0, 0≦a≦1.0, and 1.8≦b≦2.2; and y<z is satisfied.
